(19) United States
(12) Patent Application Publication
(10) Pub. No.: US 2018/0151198 A1
(43) Pub. Date: May 31, 2018

(54) MOVING IMAGE EDITING APPARATUS AND MOVING IMAGE EDITING METHOD

(71) Applicant: CASIO COMPUTER CO., LTD., Tokyo (JP)

(72) Inventor: Kazunori YANAGI, Tokyo (JP)

(73) Assignee: CASIO COMPUTER CO., LTD., Tokyo (JP)

(21) Appl. No.: 15/818,254

(22) Filed: Nov. 20, 2017

(30) Foreign Application Priority Data
Nov. 30, 2016 (JP) 2016-232019

(51) Int. Cl. G11B 27/031; G10L 25/63; G11B 27/22

(52) U.S. Cl. CPC G11B 27/031; G11B 27/22; G10L 25/63

(57) ABSTRACT

A moving image editing apparatus includes the following. A recognizer recognizes an emotion of a person recorded in a moving image from the moving image as an editing target. A specifier specifies a timewise portion of the moving image to be edited which is a timewise position different from a timewise position in which the recognizer recognizes a predetermined emotion. An editor performs an editing process on the timewise portion of the moving image to be edited, the timewise portion which is specified by the specifier.

### BACKGROUND OF THE INVENTION

### 1. Field of the Invention

The present invention relates to a moving image editing apparatus and a moving image editing method.

### 2. Description of the Related Art

Lately, an emotion analysis technique which analyzes human emotions from voice data is becoming close to practical use. As described in Japanese Patent Application Laid-Open Publication No. 2009-288446, by using such emotion analysis technique, for example, the emotion of the listener can be assumed from a karaoke movie showing the singer and the listener, and text and images can be combined with the original karaoke movie according to the emotions.

### SUMMARY OF THE INVENTION

There is provided a moving image editing apparatus including: a recognizer which recognizes a predetermined emotion of a person recorded in a moving image as an editing target; a specifier which specifies a timewise portion of the moving image to be edited which is different from a timewise position in which the recognizer recognizes the predetermined emotion; and an editor which performs an editing process on the timewise portion of the moving image to be edited, the timewise portion which is specified by the specifier.

Further, there is provided a moving image editing apparatus including: a recognizer which recognizes an emotion of a person recorded in a moving image from a voice included in the moving image as an editing target; a specifier which specifies a timewise portion of the moving image to be edited according to a recognized result by the recognizer; and an editor which performs an editing process on the timewise portion of the moving image to be edited, the timewise portion which is specified by the specifier.

Further, there is provided a moving image editing apparatus including: a recognizer which recognizes an emotion of a person recorded in a moving image as an editing target; a specifier which specifies a timewise portion of the moving image to be edited according to a recognized result by the recognizer; and an editor which performs an editing process in which an effect of editing changes over time on the timewise portion of the moving image to be edited, the timewise portion which is specified by the specifier.

Further, there is provided a moving image editing method including: recognizing a predetermined emotion of a person recorded in a moving image as an editing target; specifying a timewise portion of the moving image to be edited which is different from a timewise position in which predetermined emotion is recognized; and editing on the specified timewise portion of the moving image to be edited.

Further, there is provided a moving image editing method including: recognizing an emotion of a person recorded in a moving image from a voice included in the moving image as an editing target; specifying a timewise portion of the moving image to be edited according to a recognized result of the emotion of the person; and editing on the specified timewise portion of the moving image to be edited.

Further, there is provided a moving image editing method including: recognizing an emotion of a person recorded in a moving image as an editing target; specifying a timewise portion of the moving image to be edited according to a recognized result of the emotion of the person; and editing in which an effect of editing changes over time on the specified timewise portion of the moving image to be edited.

### BRIEF DESCRIPTION OF THE DRAWINGS

FIG. 1 is a diagram showing a schematic configuration of a moving image editing apparatus of an embodiment according to the present invention.

FIG. 2A is a diagram showing an example of a first table.

FIG. 2B is a diagram showing an example of a second table.

FIG. 3 is a flowchart showing an example of an operation regarding the moving image editing process.

FIG. 4A is a diagram showing an example of a recognizing start position and a recognizing end position of emotions.

FIG. 4B is a diagram showing another example of a recognizing start position and a recognizing end position of emotions.

### DETAILED DESCRIPTION OF THE PREFERRED EMBODIMENTS

According to the present invention, specific embodiments are described with reference to the drawings. However, the scope of the invention is not limited to the illustrated examples.

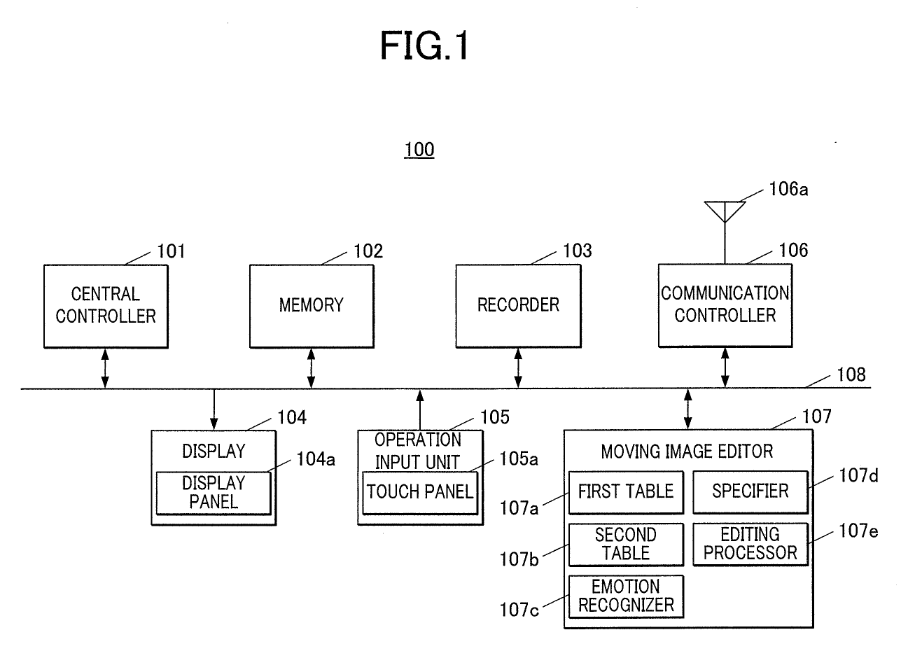

FIG. 1 is a block diagram showing a schematic configuration of a moving image editing apparatus 100 of the present embodiment applying the present invention.

As shown in FIG. 1, the moving image editing apparatus 100 of the present embodiment includes, a central controller 101, a memory 102, a recorder 103, a display 104, an operation input unit 105, a communication controller 106, and a moving image editor 107.

The central controller 101, the memory 102, the recorder 103, the display 104, the operation input unit 105, the communication controller 106, and the moving image editor 107 are connected through a bus line 108.

The central controller 101 controls each unit of the moving image editing apparatus 100. Specifically, although illustration is omitted, the central controller 101 includes a CPU (Central Processing Unit), etc., and performs various controlling operations according to various processing programs (illustration omitted) for the moving image editing apparatus 100.

For example, the memory 102 includes a DRAM (Dynamic Random Access Memory), etc., and temporarily stores data processed by the central controller 101, moving image editor 107, etc.

For example, the recorder 103 includes a SSD (Solid State Drive), etc., and records image data such as a still image or moving image coded in a predetermined compressed format (for example, JPEG format, MPEG format, etc.) by an image processor (not shown). The recorder 103 may be a recording medium (not shown) which is detachable, and may control reading data from the attached recording medium or writing data in the recording medium. The storage 103 may be connected to a network through the later described communication controller 106, and may include a storage region in a predetermined server apparatus.

The display 104 displays an image in a display region of the display panel 104a.

That is, the display 104 displays the moving image or the still image in the display region of the display panel 104a based on the image data with the predetermined size decoded by the image processor (not shown).

For example, the display panel 104a includes a liquid crystal display panel, organic EL (Electro-Luminescence) display panel, etc., but these are merely examples and the display panel 104a of the present invention is not limited to the above.

The operation input unit 105 is for performing predetermined operation of the moving image editing apparatus 100. Specifically, the operation input unit 105 includes a power source button including an ON/OFF operation of the power source, and buttons, etc. regarding selection instruction of various modes and functions (all are not shown).

When various buttons are operated by the user, the operation input unit 105 outputs the operation instruction according to the operated button to the central controller 101. The central controller 101 controls each unit to perform predetermined operation (for example, editing process of the moving image) according to the input operation instruction which is output from the operation input unit 105.

The operation input unit 105 includes a touch panel 105a provided as one with the display panel 104a of the display 104.

The communication controller 106 transmits and receives data through the communication antenna 106a and the communication network.

The moving image editor 107 includes a first table 107a, a second table 107b, an emotion recognizer 107c, a specifier 107d, and an editing processor 107e.

Each unit of the moving image editor is composed from a predetermined logic circuit, but the structure is one example and is not limited to the above.

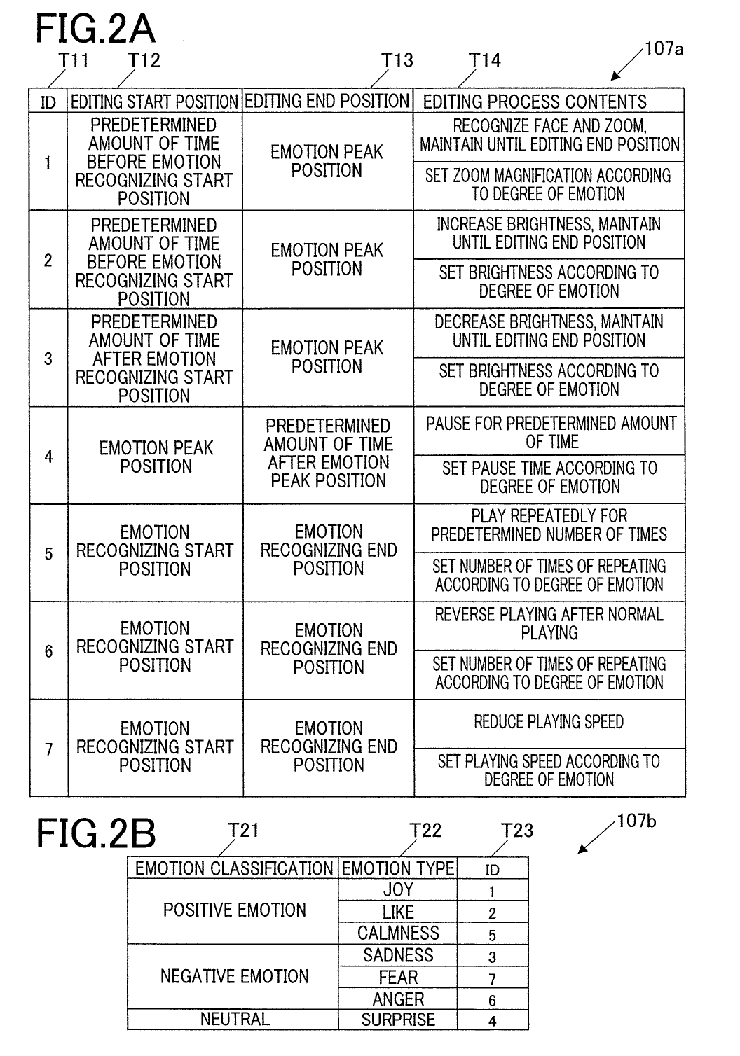

As shown in FIG. 2A, the first table 107a includes the following items, “ID” T11 to identify editing contents, “editing start position” T12 which shows editing start position, “editing end position” T13 which shows editing end position, and “editing process contents” T14 which shows contents of editing process.

In the first table 107a, for example, the editing start position corresponding to the number “1” in the item “ID” T11 is “a predetermined amount of time before emotion recognizing start position” and the editing end position is “emotion peak position”. That is, the emotion recognizer 107c specifies a timewise position in which a predetermined emotion (for example, emotion of joy) is recognized, that is, portion of the length of time different from the length of time from the recognizing start position of the predetermined emotion to the recognizing end position as the timewise portion when the moving image is edited.

As shown in FIG. 2B, the second table 107b includes the following items, “emotion classification” T21 showing classification of emotion, “emotion type” T22 showing type of emotion, and “ID” T23 showing number to specify editing content. Here, the number shown in “ID” T23 corresponds to the number shown in “ID” T11 of the first table 107a. That is, when the emotion is recognized and the type of the emotion is specified by the emotion recognizer 107c, the editing contents (editing start position, editing end position, editing process contents) are specified.

The emotion recognizer (recognizer) 107c recognizes emotions of the person recorded in the moving image from the moving image as the editing target. According to the present embodiment, the description assumes the emotion of one person is to be recognized.

Specifically, the emotion recognizer 107c generates a time series graph showing degree of each emotion of “joy”, “like”, “calmness”, “sadness”, “fear”, “anger”, “surprise” along a time series based on voice data (voice portion) included in the moving image of the editing target. Here, a threshold corresponding to each emotion is set in advance for each emotion. Since calculation of the degree of each emotion can be performed using well-known voice analysis techniques, detailed description is omitted.

Then, using the generated time series graph, the emotion recognizer 107a sequentially recognizes the emotion according to the following steps (1) to (4).

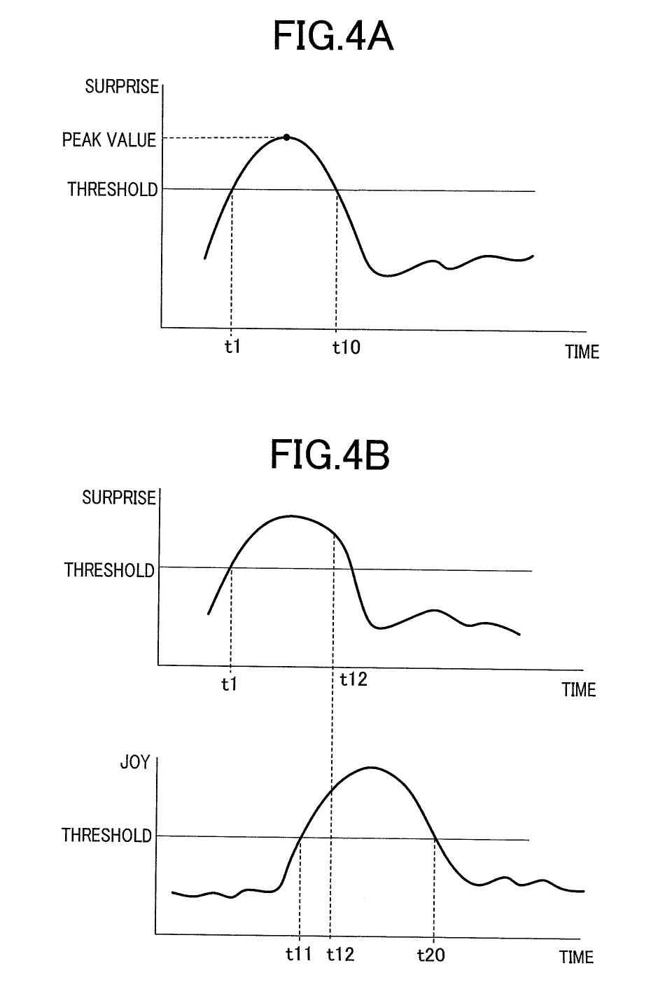

(1) As shown in FIG. 4A, the time point t1 at which it is determined that the degree of emotion (for example, the emotion of “surprise”) exceeds the threshold corresponding to the emotion is to be the emotion recognizing start position. As shown in FIG. 4B, at the time point t11 when it is determined that the degree of emotion (for example, emotion of “joy”) exceeds the threshold corresponding to the emotion, if it is determined that the degree of another emotion (for example, the emotion of “surprise”) exceeds the threshold corresponding to the another emotion, the time point t12 when the degree of the emotion exceeds the degree of the another emotion is to be the emotion recognizing start position.

(2) The type of the emotion in which the start of recognition is acknowledged at step (1) is determined.

(3) When a different emotion is recognized during a term until the degree of emotion in which the start of recognition is acknowledged in step (1) decreases to less than a threshold corresponding to the emotion, or before the degree of emotion in which the start of recognition is acknowledged in step (1) decreases to less than the threshold corresponding to the emotion, the peak value of the degree of the emotion is sequentially updated throughout the term until the recognition of the different emotion starts.

(4) As shown in FIG. 4A, the time point t10 when it is determined that the degree of emotion in which the start of recognition is acknowledged in step (1) decreases to less than the threshold corresponding to the emotion is to be the emotion recognizing end position. However, as shown in FIG. 4B, when a different emotion (for example, emotion of “joy”), is recognized before the degree of emotion (for example, emotion of “surprise”) in which the start of recognition is acknowledged in step (1) decreases to lower than the threshold corresponding to the emotion, the recognizing start position t12 of the different emotion is to be the recognizing end position for the emotion in which the start of recognition is acknowledged in step (1).

Then, when the emotion recognizer 107c ends recognition of the emotion from the beginning to the end of the voice data, the emotion recognizer 107c temporarily records in the memory 102 the emotion recognizing start position, recognizing end position, type, and peak value for each recognized emotion.

The specifier 107d specifies the timewise portion in which the moving image is edited based on the recognized result of the emotion by the emotion recognizer 107c.

Specifically, the specifier 107d specifies the timewise portion in which the moving image is edited using the first table 107a and second table 107b, and the recognizing start position, the recognizing end position, the type and the peak value of the emotion stored temporarily in the memory 102. For example, when the emotion recognizer 107c recognizes the emotion of “joy”, the specifier 107d refers to the second table 107b and obtains the number “1” to specify the editing items corresponding to the emotion type “joy” temporarily stored in the memory 102 from the item “ID” T23. Next, the specifier 107d refers to the first table 107a and obtains the editing content corresponding to the number “1” to specify the obtained editing content from the items “editing start position” T12, “editing end position” T13, and “editing process contents” T14. With this, the timewise portion of the moving image to be edited is specified. Specifically, in this case, from the item of “editing start position” T12, “a predetermined amount of time before recognizing start position of emotion (emotion of joy)” is specified as the editing start position. From the item “editing end position” T13, “emotion (emotion of joy) peak position” is specified as the editing end position. That is, the specifier 107d specifies the timewise portion of the moving image which is to be edited based on the specifying manner corresponding to the type of emotion recognized by the emotion recognizer 107c. From the item of “editing process contents” T14, “recognize and zoom on face, maintain until editing stop position” and “set zoom magnification according to degree of emotion” are specified as contents of the editing process.

The editing processor (editor) 107e performs the editing process (“editing process contents” T14) on the timewise portion (the timewise portion of the movie from “editing start position” T12 to “editing end position” T13) of the moving image to be edited specified by the specifier 107d based on the editing manner corresponding to the type of emotion recognized by the emotion recognizer 107c. Then, the editing processor 107e replaces the original timewise portion of the moving image specified as the target of editing process with the timewise portion on which the editing process is performed.

Specifically, as described above, when the emotion recognizer 107c recognizes the emotion of “joy”, the editing processor 107e performs a zoom-in process on the recognized face and a process to maintain the zoomed state until the editing end position in the timewise portion of the moving image to be edited specified by the specifier 107d, that is, the timewise portion from the predetermined amount of time before the recognizing start position of the emotion of “joy” to the peak position. The zooming magnification when the zoom-in process is performed is set to the zooming magnification according to the degree of the emotion of “joy”.

For example, when the emotion recognizer 107c recognizes the emotion of “surprise” (“ID” T11, T23 is “4”), the editing processor 107e performs the process of pausing the moving image in the timewise portion of the moving image to be edited specified by the specifier 107d, that is, the timewise portion from the peak position of the emotion of “surprise” to until a predetermined amount of time passes. The amount of time of pausing is set to an amount of time according to the degree of emotion of “surprise”. For example, when the emotion recognizer 107c recognizes the emotion of “fear” (“ID” T11, T23 is “7”), the editing processor 107e performs a process to slow the speed of the moving image in the timewise portion of the moving image to be edited specified by the specifier 107d, that is, the timewise portion from the recognizing start position of the emotion of “fear” to the recognizing end position. In this case, when the playing speed of the movie becomes slow, the playing speed of the voice also becomes slow. Therefore, the effect of editing is enhanced by making the pitch of the voice lower. The playing speed of the moving image is set to a speed according to the degree of emotion of “fear”.

Here, the editing processor 107e performs the editing process in which the editing effect changes timewise on the timewise portion of the moving image to be edited specified by the specifier 107d. The editing processor 107e performs the editing process in which the effect gradually changes over time or the editing process which has a flow of time different from the original moving image to be edited as the editing process in which the editing effect changes over time. The editing processor 107e performs the editing process according to the degree of the emotion recognized by the emotion recognizer 107c on the timewise portion of the moving image to be edited specified by the specifier 107d.

### <Moving Image Editing Process>

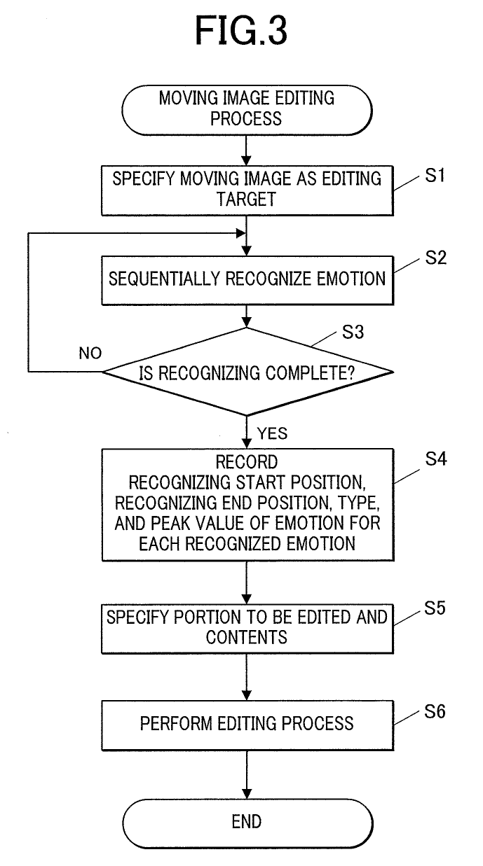

Next, the moving image editing process by the moving image editing apparatus 100 is described with reference to FIG. 3. FIG. 3 is a flowchart showing an example of an operation regarding a moving image editing process. The functions described in the flowchart are stored in a form of a readable program code and the operations are sequentially executed according to the program code. The operations according to the above-described program code transmitted through the transmitting medium such as the network by the communication controller 106 can be sequentially executed. That is, other than the recording medium, the program/data provided from external devices through the transmitting medium can be used to perform operations specific to the present embodiment.

As shown in FIG. 3, first, when the user specifies the moving image as the editing target based on predetermined operation of the operation input unit 105 from the moving image recorded in the recorder 103 (step S1), the emotion recognizer 107c reads the specified moving image from the recorder 103 and uses the voice data of the moving image to sequentially recognize the emotion from the beginning to the end of the voice data (step S2).

Next, the emotion recognizer 107c determines whether the recognition of emotion is completed from the beginning to the end of the voice data (step S3).

In step S3, when it is determined that the recognition of the emotion is not completed from the beginning to the end of the voice data (step S3; NO), the process returns to step S2, and the process is repeated. When it is determined that the recognition of the emotion is completed from the beginning to the end of the voice data (step S3; YES), the emotion recognizer 107c temporarily records the recognizing start position, the recognizing end position, the type and the peak value of the emotion for each recognized emotion in the memory 102 (step S4).

Next, the specifier 107d uses the first table 107a and the second table 107b, and the recognizing start position, the recognizing end position, the type and the peak value of the emotion recorded temporarily in the memory 102 and specifies the timewise portion of the moving image to be edited and the contents of editing (step S5).

Next, the editing processor 107e performs the editing process on the timewise portion of the moving image to be edited specified by the specifier 107d according to the editing contents of the moving image also specified by the specifier 107d. The timewise portion on which the editing process is performed is replaced with the timewise portion specified as the target of the editing process from the original moving image (step S6). With this, the moving image editing process ends.

As described above, the moving image editing apparatus 100 of the present embodiment recognizes the emotion of the person recorded in the moving image from the moving image editing target, specifies the timewise portion of the moving image to be edited which is the timewise position different from the timewise position in which the predetermined emotion is recognized, and the editing process is performed on the specified timewise portion of the moving image to be edited.

Therefore, according to the moving image editing apparatus 100 of the present embodiment, it is possible to perform editing of the moving image suitable for the predetermined emotion without considering the timewise position that the predetermined emotion is recognized. Therefore, it is possible to perform effective editing.

According to the moving image editing apparatus 100 of the present embodiment, the emotion of the person recorded in the moving image is recognized from the voice portion included in the moving image as the editing target, specifies the timewise portion of the movie in which the moving image is edited which is the timewise portion different from the timewise position when the predetermined emotion is recognized, and performs the editing process on the specified timewise portion of the movie in which the moving image is edited. Therefore, according to the moving image editing apparatus 100 of the present embodiment, more effective and visual editing is possible.

The moving image editing apparatus 100 of the present embodiment recognizes the emotion of the person recorded in the moving image only from the voice included in the editing target moving image, specifies the timewise portion of the moving image to be edited according to the recognition result of the emotion of the person, and performs the editing process on the specified timewise portion of the moving image to be edited. Therefore, according to the moving image editing apparatus 100 of the present embodiment, even if the person is not shown in the moving image, the emotion of the person can be recognized. Therefore, the chance of recognizing the emotion of the person increases, the timewise portion of the moving image to be edited according to the recognized result of the emotion of the person increases, and more effective editing can be performed.

The moving image editing apparatus 100 according to the present embodiment recognizes the emotion of the stored moving image from the editing target moving image, the timewise portion of the moving image to be edited is specified according to the recognized result of the emotion of the person, and the editing process is performed on the specified timewise portion of the moving image to be edited so that the effect of editing changes over time. Therefore, according to the moving image editing apparatus 100 of the present embodiment, the editing effect changes over time and editing suitable for the moving image can be performed. With this, more effective editing can be performed.

According to the moving image editing apparatus 100 of the present embodiment, a timewise portion with the length different from the length of time in which the predetermined emotion is recognized is specified as the timewise portion of the moving image to be edited. Therefore, the editing of the moving image suitable for the predetermined emotion can be performed without limitations of the length of time that the predetermined emotion is recognized. Consequently, more effective editing can be performed.

According to the moving image editing apparatus 100 of the present embodiment, a plurality of types of recognizable emotions are set, and the specified manner of the timewise portion of the moving image to be edited according to the type of emotion is set. When the emotion is recognized, the type of emotion is also recognized, and the timewise portion of the moving image to be edited is specified based on the specifying manner corresponding to the recognized type of emotion. Therefore, according to the moving image editing apparatus 100 of the present embodiment, there may be a wide variety of specifying manners in the timewise portion of the moving image to be edited according to the recognizable emotion. Consequently, more effective editing can be performed.

The moving image editing apparatus 100 of the present embodiment, a plurality of types of recognizable emotions are set, and the editing manner of the moving image according to the type of emotion is set. The type of emotion when the emotion is recognized is further recognized, and the editing process is performed on the specified timewise portion of the moving image to be edited based on the editing manner corresponding to the recognized type of emotion. Therefore, according to the moving image editing apparatus 100 of the present embodiment, there may be a wide variety of editing manners in the timewise portion of the moving image to be edited according to the recognizable emotion. Consequently, more effective editing can be performed.

According to the moving image editing apparatus 100 of the present embodiment, when the emotion is recognized, the degree of the emotion is further recognized. The editing process is performed on the specified timewise portion of the moving image to be edited according to the recognized degree of emotion. Therefore, more effective editing can be performed.

According to the moving image editing apparatus 100 of the present embodiment, the editing process in which the effect gradually changes or in which a flow of time different from the original moving image passes is performed as the editing process in which the effect of editing changes over time. Therefore, according to the moving image editing apparatus 100, there may be a wide variety of editing manners in the timewise portion of the moving image to be edited. Consequently, more effective editing can be performed.

According to the moving image editing apparatus 100 of the present embodiment, the timewise portion of the moving image on which the editing process is performed can be replaced with the timewise portion specified as the editing process target of the original moving image. Therefore, the timewise portion on which the editing process is performed can be seen in the series of moving images.

### [Modifications]

Next, the modifications of the present embodiment are described. Similar reference numerals are applied to the components similar to the above-described embodiment, and the description is omitted.

The moving image editing apparatus 200 of the present modification is different from the above-described embodiment in that in addition to performing the editing process on the movie portion of the moving image to be edited, background music (BGM) editing is performed to add BGM.

Specifically, in addition to the items “ID” T11, “editing start position” T12, “editing end position” T13, “editing process contents” T14, a first table 207a (not shown) of the present modification includes the following items, “BGM editing start position” T15, “BGM editing end position” T16, “BGM type” T17, and “BGM editing process contents” T18.

In the “BGM editing start position” T15, items such as “emotion recognizing start position”, “predetermined amount of time before emotion recognizing start position”, “predetermined amount of time after emotion recognizing start position” are set according to the identification number of “ID” T11, that is, recognized emotion type.

In the “BGM editing end position” T16, items such as “emotion recognizing end position”, “predetermined amount of time before emotion recognizing end position”, “predetermined amount of time after emotion recognizing end position” are set according to the identification number of “ID” T11.

In the “BGM type” T17, items such as “cheerful music”, “sad music”, “quiet music” are set according to the identification number of “ID” T11.

In the “BGM editing process contents” T18, items such as “gradually raise/lower volume from BGM editing start position to end position”, “gradually raise/lower volume from BGM editing start position to emotion peak position”, “gradually raise/lower volume from emotion peak position to BGM editing end position” are set according to the identification number of “ID” T11.

With this, the specifier 207d of the present modification refers to the first table 207a of the present modification and specifies the moving image editing start position, moving image editing end position, moving image editing process contents, BGM editing start position, BGM editing end position, BGM type, and BGM editing process contents according to the recognized type of emotion.

Then, the editing processor 207e according to the present modification performs the editing process on the timewise portion of the moving image to be edited and the BGM editing process on the target portion based on the contents specified by the specifier 207d.

The present invention is not limited to the above-described embodiments, and various modification and changes in design can be made without leaving the scope of the present invention.

According to the above-described embodiments and modifications, the editing process is performed according to the editing process contents listed in the item “editing process contents” T14 of the first table 107a, 207a. The contents of the editing process are not limited to the listed contents of the editing process. For example, the editing process such as changing the speed when the screen is switched or changing the type of editing effect when the screen is switched can be performed.

For example, editing processes such as adding fonts and telops according to the recognized type of emotion can be performed in the above-described embodiments and modifications.

According to the above-described embodiments and modifications, the contents of the editing process is specified according to the recognized type of emotion, but the present invention is not limited to the above, and the contents of the editing process can be specified according to the recognized classification of the emotion (positive emotion, negative emotion, neutral).

When voices of a plurality of people are included in the moving image of the editing target in the above-described embodiments and modification, for example, the emotion can be recognized from only the loudest voice as the target.

According to the above-described embodiments and modifications, for example, sample data recording the voice of a certain person is stored in advance. When the emotion recognizer 107c recognizes the emotion, only the voice matching the voice of the specific person based on the sample data may be the target and the emotion of the person recorded in the moving image may be recognized. In this case, the emotion recognizer 107c is able to recognize the emotion of only the specific person.

The above-described embodiments and modifications do not describe the process for the moving image newly generated by the editing process. However, such edited moving image can be stored in the recorder 102 as a new moving image. Moreover, the editing process can be started by an instruction from outside, the moving image after editing can be temporarily stored in the memory 102, and after output by playing, the moving image can be erased from the memory 102 when there is a predetermined instruction or a predetermined amount of time passes.

The embodiments of the present invention are described above, but the scope of the present invention is not limited to the above-described embodiments. The scope of the present invention is limited to the invention as claimed and its equivalents.

This application is based upon and claims the benefit of priority from Japanese Patent Application No. 2016-232019 filed on Nov. 30, 2016 the entire contents of which are incorporated herein by reference.

What is claimed is:

1. A moving image editing apparatus comprising:
a recognizer which recognizes a predetermined emotion of a person recorded in a moving image as an editing target;
a specifier which specifies a timewise portion of the moving image to be edited which is different from a timewise position in which the recognizer recognizes the predetermined emotion; and
an editor which performs an editing process on the timewise portion of the moving image to be edited, the timewise portion which is specified by the specifier.

2. The moving image editing apparatus according to claim 1, wherein,
the recognizer recognizes the emotion of the person recorded in the moving image from a voice portion included in the moving image as the editing target;
the specifier specifies a timewise portion of a movie in which the moving image is edited, the timewise portion which is different from the timewise position in which the predetermined emotion is recognized; and
the editor performs the editing process on the timewise portion of the movie in which the moving image is edited, the timewise portion which is specified by the specifier.

3. A moving image editing apparatus comprising:
a recognizer which recognizes an emotion of a person recorded in a moving image from a voice included in the moving image as an editing target;
a specifier which specifies a timewise portion of the moving image to be edited according to a recognized result by the recognizer; and
an editor which performs an editing process on the timewise portion of the moving image to be edited, the timewise portion which is specified by the specifier.

4. The moving image editing apparatus according to claim 3, wherein,
the specifier specifies a timewise portion of a movie in the moving image to be edited, the timewise portion which is different from a timewise position in which the recognizer recognizes a predetermined emotion; and
the editor performs the editing process on the timewise portion of the movie in the moving image to be edited, the timewise portion which is specified by the specifier.

5. A moving image editing apparatus comprising:
a recognizer which recognizes an emotion of a person recorded in a moving image as an editing target;
a specifier which specifies a timewise portion of the moving image to be edited according to a recognized result by the recognizer; and
an editor which performs an editing process in which an effect of editing changes over time on the timewise portion of the moving image to be edited, the timewise portion which is specified by the specifier.

6. The moving image editing apparatus according to claim 1, wherein, the specifier specifies a timewise portion with a length of time different from a length of time in which a predetermined emotion is recognized by the recognizer as a timewise portion of the moving image to be edited.

7. The moving image editing apparatus according to claim 1, wherein,
a plurality of types of emotions which can be recognized by the recognizer are set and a specified manner of the timewise portion of the moving image to be edited is set according to the type of emotion;
the recognizer further recognizes the type of emotion when the emotion is recognized; and
the specifier specifies the timewise portion of the moving image to be edited based on the specified manner corresponding to the type of emotion recognized by the recognizer.

8. The moving image editing apparatus according to claim 1, wherein,
a plurality of types of emotions which can be recognized by the recognizer are set and an editing manner of the moving image according to the type of emotion is set;
the recognizer further recognizes the type of emotion when the emotion is recognized; and
based on the editing manner corresponding to the type of emotion recognized by the recognizer, the editor performs an editing process on the timewise portion of the moving image to be edited, the timewise portion which is specified by the specifier.

9. The moving image editing apparatus according to claim 1, wherein,
the recognizer further recognizes a degree of the emotion when the emotion is recognized; and
the editor performs an editing process according to the degree of the emotion recognized by the recognizer on the timewise portion of the moving image to be edited, the timewise portion which is specified by the specifier.

10. The moving image editing apparatus according to claim 1, wherein, the editor performs the editing process in which the effect of editing changes over time on the timewise portion of the moving image to be edited, the timewise portion which is specified by the specifier.

11. The moving image editing apparatus according to claim 5, wherein, the editor performs the editing process in which the effect gradually changes or the editing process in which a flow of time is different from an original moving image to be edited is performed as the editing process in which the effect of editing changes over time.

12. The moving image editing apparatus according to claim 1, wherein, the editor replaces the timewise portion of the moving image on which the editing process is performed with the timewise portion specified as the target of the editing process in the original moving image.

13. A moving image editing method comprising:
recognizing a predetermined emotion of a person recorded in a moving image as an editing target;
specifying a timewise portion of the moving image to be edited which is different from a timewise position in which predetermined emotion is recognized; and
editing on the specified timewise portion of the moving image to be edited.

14. A moving image editing method comprising:
recognizing an emotion of a person recorded in a moving image from a voice included in the moving image as an editing target;
specifying a timewise portion of the moving image to be edited according to a recognized result of the emotion of the person; and
editing on the specified timewise portion of the moving image to be edited.

15. A moving image editing method comprising:
recognizing an emotion of a person recorded in a moving image as an editing target;
specifying a timewise portion of the moving image to be edited according to a recognized result of the emotion of the person; and
editing in which an effect of editing changes over time on the specified timewise portion of the moving image to be edited.
